(19) United States
(12) Patent Application Publication
(10) Pub. No.: US 2025/0237827 A1
(43) Pub. Date: Jul. 24, 2025

(54) PHOTONIC DEVICE AND FABRICATING METHOD THEREOF

(71) Applicant: Taiwan Semiconductor Manufacturing Company, Ltd., Hsinchu (TW)

(72) Inventors: Chen-Hua Yu, Hsinchu City (TW); Chun-Heng Liao, New Taipei City (TW); Li-Weng Chang, New Taipei City (TW); Jiun-Yi Wu, Taoyuan City (TW)

(73) Assignee: Taiwan Semiconductor Manufacturing Company, Ltd., Hsinchu (TW)

(21) Appl. No.: 18/420,674

(22) Filed: Jan. 23, 2024

(51) Int. Cl. G02B 6/42; G02F 1/035

(52) U.S. Cl. CPC G02B 6/4283; G02F 1/035

(57) ABSTRACT

A photonic device and a manufacturing method thereof are provided. The photonic device includes an oxide layer, a first waveguide structure and a semiconductor-insulator-capacitor modulator. The oxide layer has a first surface and a second surface opposite to the first surface. The first waveguide structure is formed on the first surface of the oxide layer. The semiconductor-insulator-capacitor modulator is formed on the second surface of the oxide layer. The semiconductor-insulator-capacitor modulator includes a first terminal, a second terminal and a capacitor dielectric layer. The first terminal is optically connected with the first waveguide structure. The capacitor dielectric layer is disposed between the first terminal and the second terminal.

### BACKGROUND

Many computing applications leverage optical signals for secure high-speed data transmission. Photonic Integrated Circuits (PICs) stand out as advanced systems that employ light as the carrier of information. Simultaneously, various emerging technologies are under development to enhance optical signal processing capabilities within PICs. Encompassing a range of optolectronic device and optical waveguides, PICs find applications in diverse fields such as high-speed optical communication and medical diagnostics. Given their versatile applicability, numerous researchers are dedicated to enhancing the performance and reducing the manufacturing costs of PICs.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A to FIG. 1I are schematic vertical cross-sectional views of intermediate structures that may be used to form an embodiment photonic device in accordance with various embodiments.

FIG. 2 is a flowchart illustrating stages of a method of forming an embodiment photonic device in accordance with various embodiments.

FIG. 3 is a schematic top view of an embodiment photonic device in accordance with various embodiments.

FIG. 4 is a schematic top view of another embodiment photonic device in accordance with various embodiments.

FIG. 5 is a vertical cross-sectional view of an embodiment photonic device in accordance with various embodiments.

FIG. 6 is a top view of an embodiment modulator and a waveguide structure that may be used in an embodiment photonic device in accordance with various embodiments.

FIG. 7 is a vertical cross-sectional view of an embodiment silicon waveguide in FIG. 6.

FIG. 8 is a vertical cross-sectional view of an embodiment modulator in FIG. 6.

FIG. 9 is a vertical cross-sectional view of an embodiment modulator that may be used in a photonic device in accordance with various embodiments.

FIG. 10 is a vertical cross-sectional view of an embodiment modulator that may be used in a photonic device in accordance with various embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the structure in use or operation in addition to the orientation depicted in the figures. The apparatus may be otherwise oriented (rotated 90 degrees or at other orientations) and the spatially relative descriptors used herein may likewise be interpreted accordingly.

In photonic devices (such as PICs), optical signals are transmitted using waveguides, allowing the transmission of the optical signals between various active devices such as light sources, photodetectors, modulators, and so on. In some photonic devices, a waveguide structure and active devices are formed on two different substrates. Subsequently, a bonding process is employed to bond the substrate with the waveguide structure to the one with active devices. For instance, the waveguide structure and the active devices may be formed on two different wafers, and the use of wafer-on-wafer (WOW) technology facilitates the bonding of these wafers. However, this method requires the use of two wafers, leading to expensive production costs. Additionally, some photonic devices may utilize a bonding film to connect the substrate with the waveguide structure to the one with active devices. The bonding film between the two substrates may potentially affect the transmission of light, resulting in the attenuation of optical signals. In the embodiments of this disclosure, waveguide structures and active devices are fabricated on opposing sides of a single semiconductor-on-insulator (SOI) substrate. This method not only lowers production costs but also alleviates concerns associated with the aforementioned bonding film.

In the embodiments of this disclosure, a silicon nitride waveguide is disposed on a SOI substrate. The refractive index contrast between the waveguide core material and the cladding material in a silicon nitride waveguide is lower compared to that of a silicon waveguide. Additionally, the silicon nitride waveguide boasts higher process tolerance and lower optical losses. Therefore, to minimize light transmission loss in the waveguide, utilizing silicon nitride as the waveguide core material is preferable over silicon. However, in the fabrication process of the silicon nitride waveguides, high-temperature processes are typically required, such as performing chemical vapor deposition (CVD) at elevated temperatures for silicon nitride deposition. Such high-temperature processes can adversely affect the active devices in the photonic device. In the embodiments of this disclosure, the waveguide structure is first formed above one side of the SOI substrate, followed by the fabrication of active devices above another side of the SOI substrate, thereby avoiding the aforementioned issue.

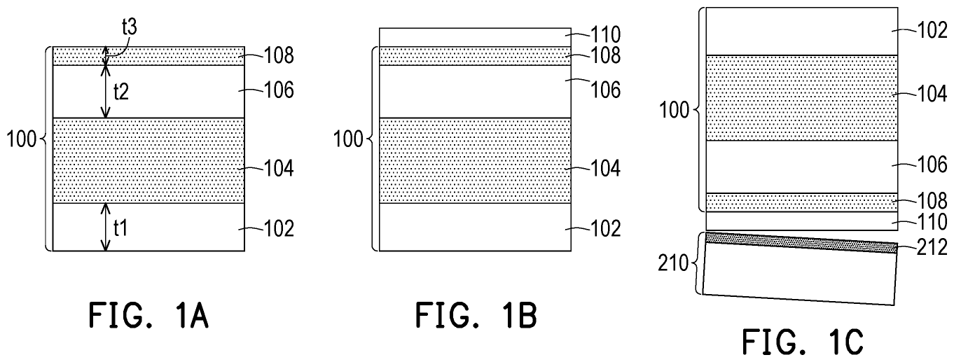

FIG. 1A to FIG. 1I are schematic vertical cross-sectional views of intermediate structures that may be used to form an embodiment photonic device 10 in accordance with various embodiments. Referring to FIG. 1A, a semiconductor-on-insulator (SOI) substrate 100 is provided. The SOI substrate 100 may be fabricated by a wafer bonding process, a silicon film transfer process, a separation by implantation of oxygen (SIMOX) process, other applicable methods, or a combination thereof. Generally, the SOI substrate 100 includes a top semiconductor layer 108 formed on a buried oxide (BOX) layer 106. The buried oxide layer 106 may be, for example, silicon oxide, silicon-rich oxide (SRO), some other oxide, some other dielectric, or any combination of the foregoing. The buried oxide layer 106 is provided on a handle substrate 104, typically a silicon or glass substrate. Other substrates, such as a multi-layered or gradient substrate may also be used. In some embodiments, the top semiconductor layer 108 may, for example, be or comprise silicon, germanium or some other suitable type of semiconductor material. That is, the SOI substrate 100 may be a silicon-on-insulator substrate, a silicon germanium-on-insulator substrate, a germanium-on-insulator substrate, and so on.

In some embodiments, an oxide layer is surrounding the handle substrate 104. A portion of the oxide layer covering the top surface of the handle substrate 104 is referred to as the buried oxide layer 106, and another portion of the oxide layer covering the bottom surface of the handle substrate 104 is referred to as the backside oxide layer 102. For instance, the backside oxide layer 102 and the buried oxide layer 106 may consist of the same material. However, this disclosure is not limited thereto. The backside oxide layer 102 and the buried oxide layer 106 may consist of different materials. The backside oxide layer 102 and the buried oxide layer 106 may have identical or different thicknesses.

In some embodiments, the backside oxide layer 102 may have a thickness t1 in a range from approximately 2.0 microns to approximately 3.0 microns (e.g., 2.5 microns), the buried oxide layer 106 may have a thickness t2 in a range from approximately 2.0 microns to approximately 3.0 microns (e.g., 2.5 microns), and the top semiconductor layer 108 may have a thickness t3 of approximately 100 nm to approximately 500 nm (e.g., from 200 nm to 400 nm). These thickness values are provided merely as examples and various other thicknesses may be used in other embodiments.

Referring to FIG. 1B, a protection layer 110 is formed on the top semiconductor layer 108. In some embodiments, the protection layer 110 completely covers a top surface of the top semiconductor layer 108.

Referring to FIG. 1C, a first carrier 210 is provided. The protection layer 110 is bonded to the first carrier 210, for instance, by utilizing an adhesive layer 212 on a top surface of the first carrier 210.

Subsequently, the backside oxide layer 102 and the handle substrate 104 above the first carrier 210 are removed, as illustrated in FIG. 1D. For example, a grinding process is employed to remove the backside oxide layer 102 and the handle substrate 104. The grinding process may include mechanical grinding, chemical mechanical polish (CMP), or other suitable processes, either individually or the combination thereof.

In this embodiment, a grinding process (such as mechanical grinding, CMP or the like) is employed to thin the buried oxide layer 106, resulting in the formation of the thinned buried oxide layer 106′ with a thickness t2′. In some instances, the thickness t2′ of the buried oxide layer 106′ ranges from 2000 angstroms to 4000 angstroms (e.g., 2500 angstroms, 3000 angstroms or 3500 angstroms). Through this process, the optical characteristics of the buried oxide layer 106′ may be adjusted, enabling components formed on both sides of the buried oxide layer 106′ to optically couple with each other.

In this embodiment, the first surface 106a of the thinned buried oxide layer 106′ is flattened (or ground) and exposed. The second surface 106b of the buried oxide layer 106′ is opposite to the first surface 106a and makes contact with the top semiconductor layer 108.

Referring to FIG. 1E, a first waveguide structure 300 is formed over the first carrier 210. The first waveguide structure 300 is formed on the first surface 106a of the buried oxide layer 106′. In this embodiment, the first waveguide structure 300 comprises multiple optical paths 302, 304, 306, 308, which are made of a core material. In some instances, the core material includes silicon nitride, lithium niobate, barium titanate, or other suitable materials or combinations thereof. The optical paths 302, 304, 306, 308 are surrounded by the first cladding dielectric layer 310. In some embodiments, the material of the first cladding dielectric layer 310 includes oxide, such as silicon oxide or the like. In some embodiments, the first cladding dielectric layer 310 and the buried oxide layer 106′ comprise the same material.

The first waveguide structure 300 can be designed to possess a higher index of refraction compared to the first cladding dielectric layer 310. This difference in refractive indices leads to the preferential propagation of light within the first waveguide structure 300, owing to the phenomenon of total internal reflection resulting from its higher index of refraction relative to the first cladding dielectric layer 310.

In some instances, optical paths 302, 304, 306, 308 with varying horizontal heights are achieved by multiple deposition process of core material layers, multiple patterning process of core material layers, and multiple deposition process of oxide layers. The oxide layers formed through the aforementioned multiple depositions are interconnected, constituting the first cladding dielectric layer 310. Patterned core material layers are sandwiched between adjacent oxide layers, forming optical paths. In some embodiments, there are various vertical distances between optical paths 302, 304, 306, 308 and the buried oxide layer 106′. For example, the vertical distance between optical paths 302 and the buried oxide layer 106′ is the shortest, while optical paths 306 have the longest vertical distance from the buried oxide layer 106′. In some embodiments, the formation process of the first waveguide structure 300 incorporates a high-temperature step. For instance, a high-temperature process, such as the CVD process used during the deposition of core material, involves temperatures exceeding 500 degrees Celsius. In some embodiments, the temperature for the CVD process used to deposit the first waveguide structure 300 exceeds 600 degrees Celsius and may even surpass 700 degrees Celsius.

In some embodiments, adjacent optical paths 302, 304, 306, 308 are optically coupled with each other. When the thickness of the portion of the first cladding dielectric layer 310 between adjacent optical paths 302, 304, 306, 308 is sufficiently thin, light can pass through the first cladding dielectric layer 310 and propagate between different optical paths 302, 304, 306, 308. In other words, if the distances between adjacent optical paths 302, 304, 306, 308 are close enough, optical signals can be transmitted between the neighboring optical paths 302, 304, 306, 308.

Referring to FIG. 1F, the first carrier 210 is removed, and the first waveguide structure 300, the first cladding dielectric layer 310, the buried oxide layer 106′, the top semiconductor layer 108 and the protection layer 110 are placed on a second carrier 220. In some embodiment, the first cladding dielectric layer 310 is bonded to the second carrier 220, for instance, by utilizing an adhesive layer 222 on a top surface of the second carrier 220.

Referring to FIG. 1G, the protection layer 110 is removed, so as to expose the top semiconductor layer 108. In some embodiments, the removal of the protection layer 110 is achieved through processes such as grinding, etching, or other suitable methods.

Referring to FIG. 1H, an active device layer 400 is formed above the second surface 106b of the buried oxide layer 106′. In this embodiment, the active device layer 400 includes, for example, a first active device 410 and a second active device 420. In some instances, the first active device 410 and the second active device 420 comprise electro-optic devices, such as photodiodes, modulators, or the combinations thereof, or the like. For example, one of the first active device 410 and the second active device 420 may be a photodetector, such as a p-i-n photodetector, a p-n photodetector, an avalanche photodetector, or the like, and another one of the first active device 410 and the second active device 420 may be an electro-optical modulator.

In some embodiments, a portion of the first active device 410 and a portion of the second active device 420 is constituted by a portion of the top semiconductor layer 108. For example, one or more etching processes are employed to pattern the top semiconductor layer 108, forming at least a portion of the semiconductor layers in the first active device 410 and the second active device 420.

In some embodiments, the active device layer 400 further includes a second waveguide structure (not shown in FIG. 1H). In some instances, the second waveguide structure is formed by patterning the top semiconductor layer 108, and it comprises different materials than the first waveguide structure 300. In some embodiments, patterning the top semiconductor layer 108 of the SOI substrate not only forms at least a portion of the semiconductor layers in the first active device 410 and the second active device 420 but also allows for the creation of the additional second waveguide structure.

In some embodiments, either one or both of the first active device 410 and the second active device 420 are optically coupled to the first waveguide structure 300. In some embodiments, the first active device 410 and the second active device 420 may be optically coupled with each other through the first waveguide structure 300 disposed on the first surface 106a of the buried oxide layer 106′ or the second waveguide structure (not shown in FIG. 1H) disposed on the second surface 106b of the buried oxide layer 106′.

In this embodiment, completing the formation of the first waveguide structure 300 before forming the first active device 410 and the second active device 420 helps to avoid potential damage to the active devices caused by the high-temperature processes involved in the formation of the first waveguide structure 300. For example, when at least one of the first active device 410 and the second active device 420 includes semiconductor materials with a relatively lower melting point (such as germanium with a melting point of approximately 938 degrees Celsius), these semiconductor materials may experience diffusion or even melting during the high-temperature processes for forming the first waveguide structure 300. Therefore, manufacturing the first waveguide structure 300 before forming the first active device 410 and the second active device 420 is an effective way to prevent the issues mentioned above.

A second cladding dielectric layer 430 is formed above the second surface 106b of the buried oxide layer 106′. In some embodiments, the material of the second cladding dielectric layer 430 includes oxide, such as silicon oxide or the like. In some embodiments, the second cladding dielectric layer 430 surrounds the first active device 410, the second active device 420, and the second waveguide structure (not shown in FIG. 1H). In some embodiments, the second cladding dielectric layer 430 and the buried oxide layer 106′ comprise the same material.

A plurality of conductive vias 432, 434 are disposed within the second cladding dielectric layer 430 and electrically connected with the first active device 410 and the second active device 420, respectively. In this regard, a patterned photoresist (not shown) may be formed over the second cladding dielectric layer 430. The patterned photoresist may then be used as a mask during an anisotropic etch process that may be performed to generate via cavities (not shown). The via cavities may then be filled with a conductive material to thereby form the conductive vias 432, 434. The conductive material may include a metallic liner material and a metallic fill material. The metallic liner material may include a conductive metallic nitride or a conductive metallic carbide such as TiN, TaN, WN, TIC, TaC, and/or WC. The metallic fill material may include W, Cu, Al, Co, Ru, Mo, Ta, Ti, alloys thereof, and/or combinations thereof. Other suitable conductive materials within the contemplated scope of this disclosure may also be used.

An insulation layer 440 is formed on the second cladding dielectric layer 430. Conductive features 442, 444 are embedded in the insulation layer 440. In this regard, a patterned photoresist (not shown) may be formed over the insulation layer 440. The patterned photoresist may then be used to etch unmasked portions of the insulation layer 440 to form cavities in the insulation layer 440. The patterned photoresist may then be removed by ashing or by dissolution with a solvent. The conductive features 442, 444 may then be formed by depositing a conductive material in the cavities formed in the insulation layer 440. The conductive material may include a metallic liner material and a metallic fill material. The metallic liner material may include a conductive metallic nitride or a conductive metallic carbide such as TiN, TaN, WN, TiC, TaC, and/or WC. The metallic fill material may include W, Cu, Al, Co, Ru, Mo, Ta, Ti, alloys thereof, and/or combinations thereof. Other suitable conductive materials within the contemplated scope of this disclosure may also be used. In some example embodiments, the conductive features 442, 444 may include signal lines.

Finally, the second carrier 220 is removed, completing the photonic device 10 in this embodiment, as shown in FIG. 1I.

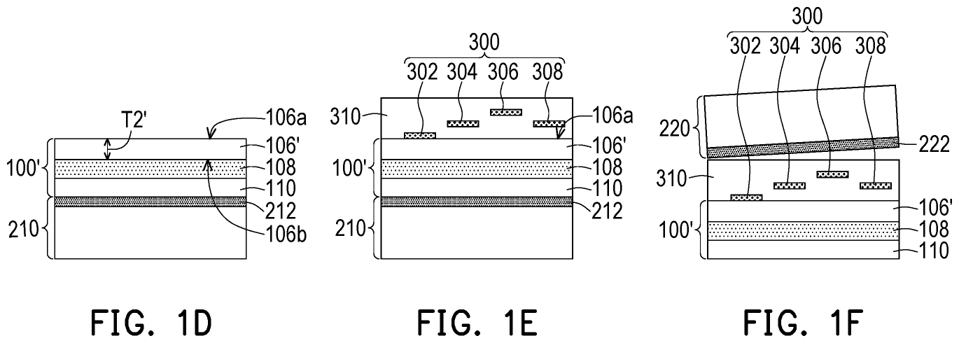

FIG. 2 is a flowchart illustrating stages of a method of forming an embodiment photonic device in accordance with various embodiments. In step S1, an oxide layer and a semiconductor layer on the oxide layer are provided. As depicted in FIG. 1A to FIG. 1D, the buried oxide layer 106′ (referred to as the oxide layer in FIG. 2) and the top semiconductor layer 108 (referred to as the semiconductor layer in FIG. 2) are provided.

In step S2, a first waveguide structure is formed on the oxide layer, as shown in FIG. 1E.

In step S3, an active device is formed on a side of the oxide layer opposite to the first waveguide structure. As depicted in FIG. 1F to FIG. 1H, the first active device 410 and the second active device 420 are formed on a side of the buried oxide layer 106′ (referred to as the oxide layer in FIG. 2) opposite to the first waveguide structure 300.

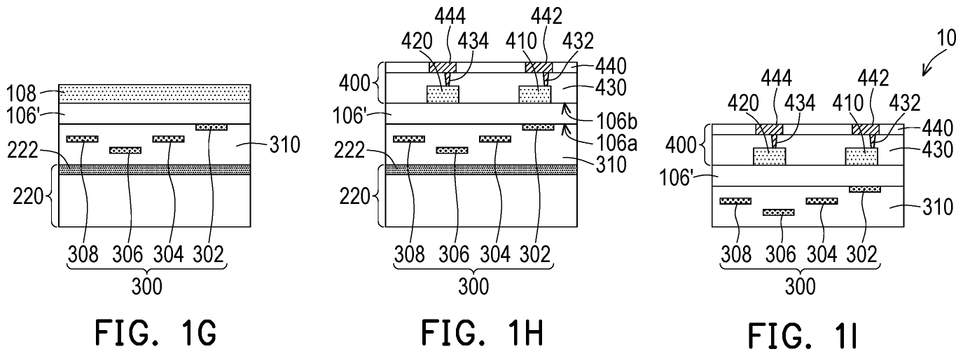

FIG. 3 is a schematic top view of a photonic device 20 in accordance with various embodiments. It should be noted herein that, in embodiments provided in FIG. 3, element numerals and partial content of the embodiments provided in FIG. 1A to FIG. 1I are followed, the same or similar reference numerals being used to represent the same or similar elements, and description of the same technical content being omitted. For a description of an omitted part, reference may be made to the foregoing embodiment, and the descriptions thereof are omitted herein.

Referring to FIG. 3, a second waveguide structure 450, the first active device 410 and the second active device 420 are formed on the second surface 106b of the buried oxide layer 106′. For example, the top semiconductor layer (referring to the top semiconductor layer 108 in FIG. 1G) is patterned to form the second waveguide structure 450, a semiconductor layer (not shown in FIG. 3) of the first active device 410 and a semiconductor layer (not shown in FIG. 3) of the second active device 420. In some embodiments, the patterning process of the top semiconductor layer involves one or more photolithography processes and one or more etching processes. Through the complementary use of the photolithography processes and the etching processes, various forms of semiconductor layers suitable for the first active device 410 and the second active device 420, as well as various forms of the second waveguide structure 450, may be created.

In some embodiments, at least one of the second waveguide structure 450, the first active device 410 and the second active device 420 is optically coupled to the first waveguide structure (referring to the first waveguide structure 300 in FIG. 1I). In some embodiments, the second waveguide structure 450 is optically coupled with the first active device 410 and/or the second active device 420. In some embodiments, the second waveguide structure 450 is physically connected with the first active device 410 and/or the second active device 420.

In some embodiments, a material of the first waveguide structure on the first surface of the buried oxide layer 106′ is different from a material of the second waveguide structure 450 on the second surface 106b of the buried oxide layer 106′. For example, a material of the first waveguide structure includes silicon nitride, lithium niobate, barium titanate, or the like, or the combination thereof, and a material of the second waveguide structure 450 includes silicon or the like. In some embodiments, a refractive index of the second waveguide structure 450 is higher than a refractive index of the first waveguide structure 300.

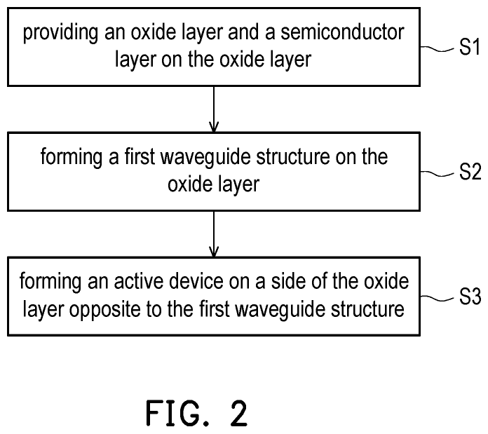

FIG. 4 is a schematic top view of a photonic device 30 in accordance with various embodiments. It should be noted herein that, in embodiments provided in FIG. 4, element numerals and partial content of the embodiments provided in FIG. 1A to FIG. 1I are followed, the same or similar reference numerals being used to represent the same or similar elements, and description of the same technical content being omitted. For a description of an omitted part, reference may be made to the foregoing embodiment, and the descriptions thereof are omitted herein.

Referring to FIG. 4, the first active device 410 and the second active device 420 are formed on the second surface 106b of the buried oxide layer 106′. In some embodiments, the first active device 410 is optically coupled to the second active device 420 through the optical path 302 of the first waveguide structure 300, which is disposed on the first surface of the buried oxide layer 106′.

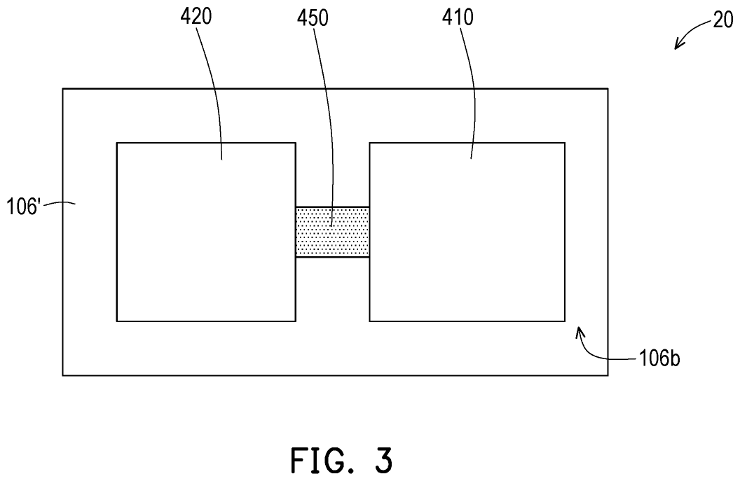

FIG. 5 is a vertical cross-sectional view of a photonic device 40 in accordance with various embodiments. It should be noted herein that, in embodiments provided in FIG. 5, element numerals and partial content of the embodiments provided in FIG. 1A to FIG. 1I are followed, the same or similar reference numerals being used to represent the same or similar elements, and description of the same technical content being omitted. For a description of an omitted part, reference may be made to the foregoing embodiment, and the descriptions thereof are omitted herein.

Referring to FIG. 5, the first active device 410A may be a photodetector, such as a germanium photodetector. In some embodiments, the first active device 410A comprises a semiconductor layer 412A and a photosensitive layer 414 embedded in the semiconductor layer 412A. In some embodiments, the semiconductor layer 412A is formed by patterning the top semiconductor layer (refer to the top semiconductor layer 108 in FIG. 1G) of the SOI substrate. The patterning process for forming the semiconductor layer 412A may involve one or more photolithography processes and one or more etching processes, and one or more masks may be required. In some embodiments, the semiconductor layer 412A is doped through one or more implantation process to form p-type doping regions (not shown) and/or n-type doping regions (not shown) within the semiconductor layer 412A.

In some embodiments, the conductive vias 432 consist of metallic materials and are electrically connected to the semiconductor layer 412A. Additionally, in some embodiments, salicide material portions 416 are formed between the conductive vias 432 and the semiconductor layer 412A. The salicide material portions 416 refer to metal/silicon compounds that establish electrical connections between the respective metallic and semiconductor materials.

In some embodiments, optical signals travel from the optical path 302 of the first waveguide structure 300, pass through the buried oxide layer 106′, reach the first active device 410A, and are then converted into electrical signals by the first active device 410A. The electrical signals can be transmitted through the conductive features 442.

In some embodiments, the first active device 410 and/or the second active device 420 in FIG. 1I may have a structure similar to the first active device 410A, but this disclosure is not limited thereto. The first active device 410 and/or the second active device 420 may also be other types of optical components.

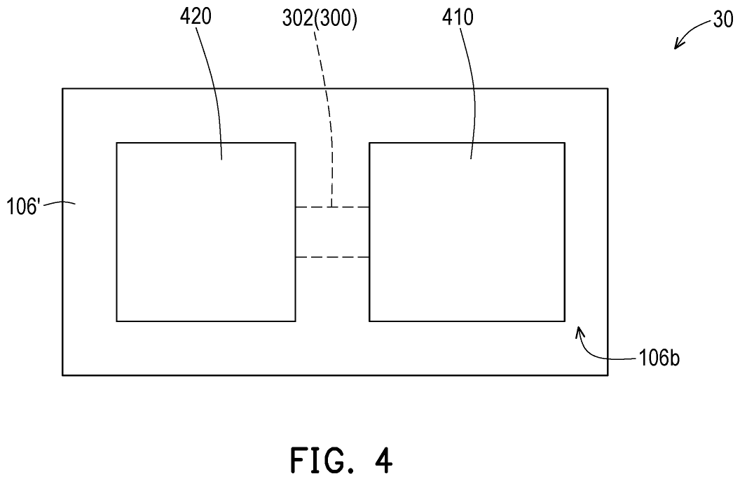

FIG. 6 is a top view of a first active devices 410B and a waveguide structure 450 that may be used in a photonic device in accordance with various embodiments. Referring to FIG. 6, the first active devices 410B are electro-optic modulators (EOMs) and connected with the second waveguide structure 450. The first waveguide segment 452a of the second waveguide structure 450 is designed to receive an input optical signal, while the second waveguide segment 452b of the second waveguide structure 450 is configured to output a modulated optical signal. As illustrated, the first waveguide segment 452a bifurcates into a first waveguide segment 454a and a second waveguide segment 454b, collectively acting as a beam splitter.

An input signal received by the first waveguide segment 452a undergoes splitting into two optical signals, carried by the first waveguide segment 454a and the second waveguide segment 454b, respectively. The first optical signal, carried by the first waveguide segment 452a, is directed to one of the first active devices 410B (i.e., an electro-optic modulator), while the second optical signal, carried by the second waveguide segment 452b, is directed to another one of the first active devices 410B (i.e., another electro-optic modulator). The first active devices 410B modify the amplitude and/or phase of the respective first and second optical signals.

The modified first optical signal, transmitted along a third waveguide segment 454c, and the modified second optical signal, transmitted along a fourth waveguide segment 454d, are then combined to create an output optical signal directed to the second waveguide segment 452b. In this configuration, the third waveguide segment 454c is optically coupled to the one of the first active devices 410B, and the fourth waveguide segment 454d is optically coupled to the another one of the first active devices 410B. Consequently, the third waveguide segment 454c, the fourth waveguide segment 454d, and the second waveguide segment 452b together serve as a beam combiner. The first active devices 410B modulate their respective first and second optical signals using an electro-optic effect. Notably, the electro-optic material within each active device 410B exhibits optical properties, such as the index of refraction and absorption coefficient, that vary based on an applied electrical bias to the active devices 410B.

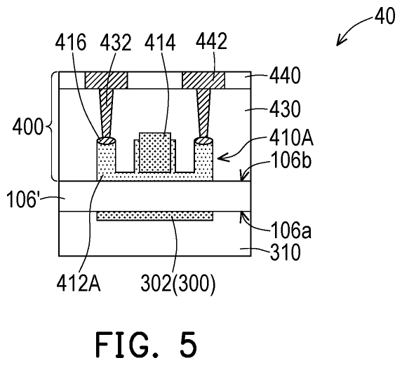

FIG. 7 is a vertical cross-sectional view taken along line A-A′ of FIG. 6. The second waveguide structure 450 is surrounded by the second cladding dielectric layer 430. The second waveguide structure 450 and the second cladding dielectric layer 430 are designed to be transparent to light of a specific wavelength, such as infrared radiation. In some embodiments, the second waveguide structure 450 is formed by patterning the top semiconductor layer (refer to the top semiconductor layer 108 in FIG. 1G) of the SOI substrate. The patterning process may involve one or more photolithography processes and one or more etching processes, and one or more masks may be required.

The second waveguide structure 450 can be designed to possess a higher index of refraction compared to the second cladding dielectric layer 430. For instance, the second waveguide structure 450 may be composed of doped or undoped silicon (e.g., index of refraction 3.88), while the second cladding dielectric layer 430 may consist of silicon oxide (e.g., index of refraction 1.46). This difference in refractive indices leads to the preferential propagation of light within the second waveguide structure 450, owing to the phenomenon of total internal reflection resulting from its higher index of refraction relative to the second cladding dielectric layer 430.

For example, an optical signal may propagate within the second waveguide structure 450, exhibiting an electric field distribution confined to a central region 451 of the second waveguide structure 450. The particular shape of the second waveguide structure 450 illustrated in FIG. 7 is merely an example, and the structure may assume various other shapes depending on different applications.

In certain embodiments, optical signals travel from the optical path 302 of the first waveguide structure 300, pass through the buried oxide layer 106′, and then propagate in the second waveguide structure 450.

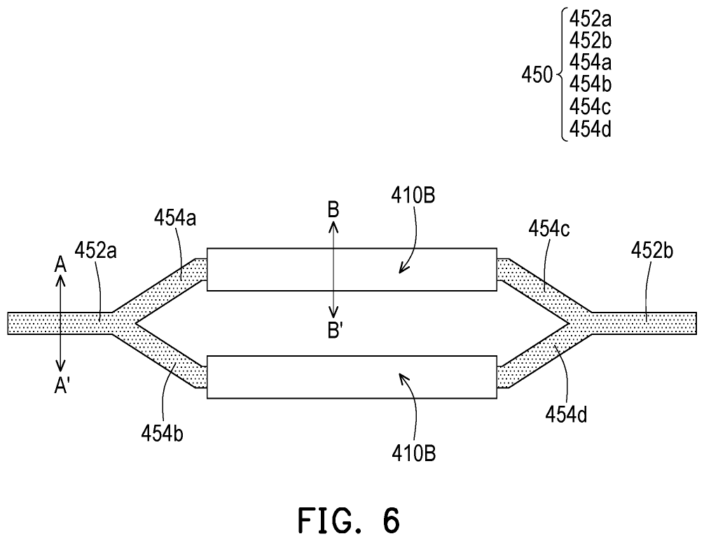

FIG. 8 is a vertical cross-sectional view taken along line B-B′ of FIG. 6. Referring to FIG. 8, the active device 410B comprises a semiconductor layer 412B, similar to the structures of the second waveguide structure 450 discussed earlier with reference to FIG. 7. Consequently, an optical signal propagates within the semiconductor layer 412B, exhibiting an electric field distribution confined to a central region 413 of the semiconductor layer 412B. In contrast to the second waveguide structure 450 of FIG. 7, the semiconductor layer 412B of the active device 410B features a doping profile that demonstrates an electro-optic effect.

For example, the central region 413 of the active device 410B may be doped to create a p-n junction, with p-type dopants present on one side (to the left of the dashed line 411) and n-type dopants on the other side (to the right of the dashed line 411) of the central region 413.

The active device 410B is electrically connected with two conductive vias 432. Applying a potential difference (voltage or bias) between these conductive vias 432 can modify the distribution of electrical charge carriers within the central region 413. Utilizing the free carrier dispersion effect in the semiconductor layer 412B, the optical properties of the central region 413 can be altered by adjusting the carrier distribution through an applied bias. For example, in forward bias, carriers may be injected into the p-n junction, reducing the size of the depletion region. In reverse bias, carriers may be depleted, thereby increasing the size of the depletion region. In a specific configuration, the active device 410B may operate in reverse bias (depletion mode) to maintain a low concentration of free carriers, resulting in relatively low optical absorption in the central region 413.

In some embodiments, the semiconductor layer 412B is formed by patterning the top semiconductor layer (refer to the top semiconductor layer 108 in FIG. 1G) of the SOI substrate. The patterning process may involve one or more photolithography processes and one or more etching processes, and one or more masks may be required.

In some embodiments, the first active device 410 and the second waveguide structure 450 (as shown in FIG. 7) are integrated, and they can be directly connected or optically coupled together.

In some embodiments, the first active device 410 and/or the second active device 420 in FIG. 1I may have a structure similar to the first active device 410B, but this disclosure is not limited thereto. The first active device 410 and/or the second active device 420 may also be other types of optical components.

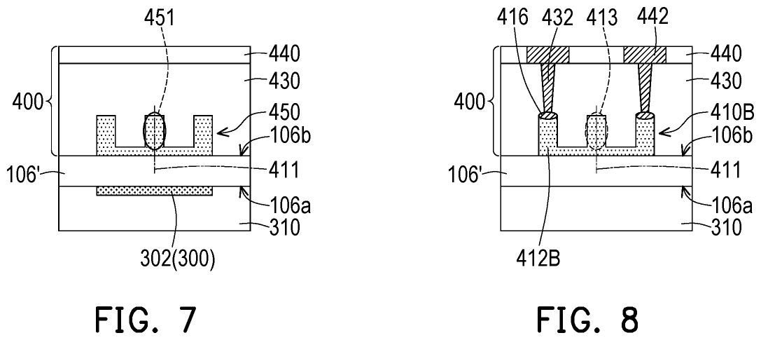

FIG. 9 is a vertical cross-sectional view of a first active device 410C that may be used in a photonic device in accordance with various embodiments. It should be noted herein that, in embodiments provided in FIG. 9, element numerals and partial content of the embodiments provided in FIG. 1A to FIG. 1I are followed, the same or similar reference numerals being used to represent the same or similar elements, and description of the same technical content being omitted. For a description of an omitted part, reference may be made to the foregoing embodiment, and the descriptions thereof are omitted herein.

Referring to FIG. 9, the first active device 410C is a semiconductor-insulator-capacitor (SISCAP) modulator. The first active device 410C is formed on the second surface 106b of the oxide layer 106′.

The first active device 410C comprises a first semiconductor structure 412C and a second semiconductor structure 418C, separated by an insulator 415. Specifically, the first semiconductor structure 412C may consist of doped silicon, the second semiconductor structure 418C may be composed of doped polysilicon, and the insulator 415 may be a suitable oxide like silicon oxynitride, and so on. Consequently, the first semiconductor structure 412C serves as the first terminal of the SISCAP modulator, the second semiconductor structure 418C serves as the second terminal of the SISCAP modulator, and the insulator 415 acts as the capacitor dielectric.

The first semiconductor structure 412C is electrically coupled to one of the conductive via 432, and the second terminal is electrically coupled to another one of the conductive via 432. In this arrangement, the metallic materials of two conductive vias 432 establish electrical connections with the first semiconductor structure 412C and the second semiconductor structure 418C, respectively, through the formation of salicide material portions 416 (i.e., metal/silicon compounds). These salicide material portions 416 serve to electrically connect the corresponding metallic and semiconductor materials.

A core portion CP in the first active device 410C constitutes an optical waveguide where the electric field distribution of the propagating optical wave is confined to a waveguide structure 413C formed between the first terminal (i.e., the first semiconductor structure 412C), the second terminal (i.e., the second semiconductor structure 418C), and the insulator 415. Similar to the active device 410B in FIG. 8, applying a voltage difference between the first terminal 412C and the second terminal 418C can alter the optical properties of the optical waveguide by modifying the free carrier concentration within the material of the SISCAP modulators (i.e., the first active device 410C).

Generally, the charge stored in a capacitor is proportional to the capacitance, which, in turn, is proportional to the dielectric constant of the insulator 415 and inversely proportional to the thickness of the insulator 415. Therefore, for a given applied voltage, the stored charge on the capacitor is directly related to the dielectric constant and inversely related to the thickness of the insulator 415. To enhance the electro-optic effect and, consequently, improve the modulator efficiency, it is advantageous to increase the capacitance of the SISCAP modulators (i.e., the first active device 410C) by utilizing a thin insulator 415 with a high dielectric constant.

The first active device 410C may offer advantages over the first active device 410B shown in FIG. 8. These embodiments are rooted in a process that generates a thin SiON insulator 415 with a high dielectric constant. Consequently, the first active device 410C may demonstrate significantly increased capacitance, leading to enhanced electro-optic properties when compared to p-n junction modulators, such as those described in FIG. 8.

In an example embodiment, the first semiconductor structure 412C may consist of p-doped silicon, the second semiconductor structure 418C may comprise n-doped polysilicon, and the insulator 415 may be composed of silicon oxynitride. Each of the first semiconductor structure 412C, the second semiconductor structure 418C, and the insulator 415 may possess a length along the optical propagation direction (i.e., into the plane of the figure).

In some embodiments, the semiconductor layer 412C is formed by patterning the top semiconductor layer (refer to the top semiconductor layer 108 in FIG. 1G) of the SOI substrate. The patterning process may involve one or more photolithography processes and one or more etching processes, and one or more masks may be required.

In some embodiments, the first semiconductor structure 412C is optically coupled to the optical path 302 of the first waveguide structure 300, situated on the first surface 106a of the buried oxide layer 106′. In some embodiments, a second waveguide structure (not shown in FIG. 9) is formed on the second surface 106b of the buried oxide layer 106′. The first semiconductor structure 412C may be optically coupled to or physically connected with the second waveguide structure.

In some embodiments, the first active device 410 and/or the second active device 420 in FIG. 1I may have a structure similar to the first active device 410C, but this disclosure is not limited thereto. The first active device 410 and/or the second active device 420 may also be other types of optical components.

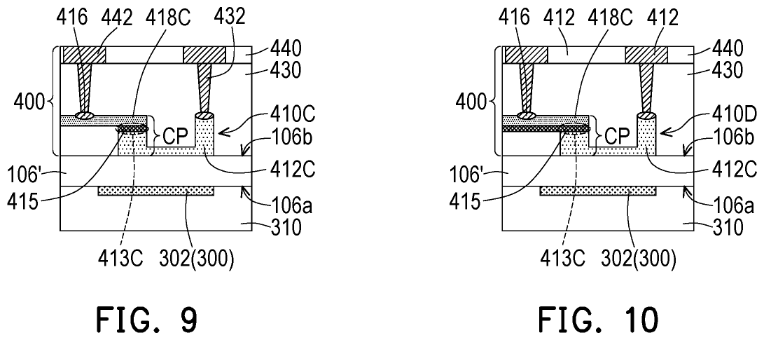

FIG. 10 is a vertical cross-sectional view of a first active device 410D that may be used in a photonic device in accordance with various embodiments. It should be noted herein that, in embodiments provided in FIG. 10, element numerals and partial content of the embodiments provided in FIG. 1A to FIG. 1I are followed, the same or similar reference numerals being used to represent the same or similar elements, and description of the same technical content being omitted. For a description of an omitted part, reference may be made to the foregoing embodiment, and the descriptions thereof are omitted herein.

The first active device 410D in FIG. 10 shares a similar structure with the first active device 410C in FIG. 9, with the main difference being that the insulator 415 in the first active device 410C is only located between the first semiconductor structure 412C and the second semiconductor structure 418C. However, the insulator 415 covers the entire bottom surface of the second semiconductor structure 418C in the first active device 410D.

In this embodiment, in the formation of the first active device 410D, the insulator 415 and the second semiconductor structure 418C, for example, can undergo patterned processes using the same photomask, thus saving production costs.

In some embodiments, the first active device 410 and/or the second active device 420 in FIG. 1I may have a structure similar to the first active device 410D, but this disclosure is not limited thereto. The first active device 410 and/or the second active device 420 may also be other types of optical components.

In the embodiments presented in this disclosure, a singular SOI substrate suffices for the creation of both waveguide structures and active devices. This not only results in a reduction of production costs for the photonic device but also mitigates the losses incurred during the transmission of optical signals between waveguide structures and active devices.

In an embodiment of the present disclosure, a method for fabricating a photonic device may include providing a semiconductor-on-insulator (SOI) substrate comprising a buried oxide layer and a top semiconductor layer on the buried oxide layer, thinning down the buried oxide layer from a first side of the buried oxide layer, forming a first waveguide structure above the first side of the buried oxide layer, and forming a first active device above a second side of the buried oxide layer opposite to the first side, wherein the first active device is optically coupled to the first waveguide structure.

In another embodiment of the present disclosure, a method for fabricating a photonic device may include providing an oxide layer and a semiconductor layer on the oxide layer, forming a first waveguide structure on the oxide layer, and forming an electro-optical device on a side of the oxide layer opposite to the first waveguide structure, wherein forming the electro-optical device comprises patterning the semiconductor layer to form a semiconductor structure of the electro-optical device.

An embodiment photonic device of the present disclosure includes an oxide layer, a first waveguide structure, and a semiconductor-insulator-capacitor modulator. The oxide layer has a first surface and a second surface opposite to the first surface. The first waveguide structure is formed on the first surface of the oxide layer. The semiconductor-insulator-capacitor modulator is formed on the second surface of the oxide layer. The semiconductor-insulator-capacitor modulator includes a first terminal optically connected with the first waveguide structure, a second terminal and a capacitor dielectric layer disposed between the first terminal and the second terminal.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for fabricating a photonic device, comprising:
providing a semiconductor-on-insulator (SOI) substrate comprising a buried oxide layer and a top semiconductor layer on the buried oxide layer;
thinning down the buried oxide layer from a first side of the buried oxide layer;
forming a first waveguide structure above the first side of the buried oxide layer; and
forming a first active device above a second side of the buried oxide layer opposite to the first side, wherein the first active device is optically coupled to the first waveguide structure.

2. The method of claim 1, wherein the first active device comprises:
a first terminal optically connected with the first waveguide structure, wherein the first terminal is formed by patterning the top semiconductor layer;
a second terminal; and
a capacitor dielectric layer disposed between the first terminal and the second terminal.

3. The method of claim 1, further comprising:
etching the top semiconductor layer to form a second waveguide structure, wherein the second waveguide structure is optically coupled to the first waveguide structure and the first active device.

4. The method of claim 1, further comprising:
forming a protection layer on the top semiconductor layer;
bonding the protection layer to a first carrier;
forming the first waveguide structure over the first carrier;
removing the first carrier;
placing the first waveguide structure on a second carrier;
removing the protection layer; and
forming the first active device over the second carrier layer.

5. The method of claim 1, further comprising:
forming a second active device on the second side of the buried oxide layer, wherein the second active device is optically coupled to the first active device through the first waveguide structure.

6. The method of claim 1, further comprising:
forming a second active device and a second waveguide structure on the second side of the buried oxide layer, wherein the second active device is optically coupled to the first active device through the second waveguide structure.

7. The method of claim 1, further comprising:
forming a second waveguide structure on the second side of the buried oxide layer, wherein a material of the first waveguide structure is different from a material of the second waveguide structure.

8. The method of claim 1, wherein a process of forming the first waveguide structure comprises a high-temperature process exceeding 700 degrees Celsius, and the first active device is a germanium photodetector.

9. A method for fabricating a photonic device, comprising:
providing an oxide layer and a semiconductor layer on the oxide layer;
forming a first waveguide structure on the oxide layer; and
forming an electro-optical device on a side of the oxide layer opposite to the first waveguide structure, wherein forming the electro-optical device comprises patterning the semiconductor layer to form a semiconductor structure of the electro-optical device.

10. The method of claim 9, wherein a material of the first waveguide structure comprises at least one of silicon nitride, lithium niobate, and barium titanate, and the semiconductor structure of the electro-optical device is optically coupled to the first waveguide structure through the oxide layer.

11. The method of claim 9, further comprising:
forming a second waveguide structure on the side of the oxide layer opposite to the first waveguide structure, wherein a refractive index of the second waveguide structure is higher than a refractive index of the first waveguide structure.

12. A photonic device, comprising:
an oxide layer having a first surface and a second surface opposite to the first surface;
a first waveguide structure formed on the first surface of the oxide layer; and
a semiconductor-insulator-capacitor modulator formed on the second surface of the oxide layer, wherein the semiconductor-insulator-capacitor modulator comprises:
a first terminal optically connected with the first waveguide structure;
a second terminal; and
a capacitor dielectric layer disposed between the first terminal and the second terminal.

13. The photonic device of claim 12, wherein a material of the first terminal comprises silicon, a material of the second terminal comprises polysilicon, and a material of the capacitor dielectric layer comprises a SiON layer.

14. The photonic device of claim 13, wherein:
the silicon of the first terminal further comprises a p-typed doping; and
the polysilicon of the second terminal further comprises an n-type doping.

15. The photonic device of claim 12, further comprising:
a photodetector, formed on the first surface of the oxide layer and optically connected with the first waveguide structure.

16. The photonic device of claim 12, further comprising:
a second waveguide structure, formed on the second surface of the oxide layer, wherein a material of the first waveguide structure is different from a material of the second waveguide structure.

17. The photonic device of claim 12, further comprising:
a second waveguide structure, formed on the second surface of the oxide layer, wherein the semiconductor-insulator-capacitor modulator is optically connected with the second waveguide structure.

18. The photonic device of claim 12, further comprising:
a second waveguide structure, formed on the second surface of the oxide layer, wherein the first terminal is physically connected with the second waveguide structure.

19. The photonic device of claim 18, wherein a material of the first terminal and the second waveguide structure comprises silicon.

20. The photonic device of claim 12, wherein a thickness of the oxide layer is from 2000 angstrom to 4000 angstrom.
